(19) United States
(12) Patent Application Publication
(10) Pub. No.: US 2014/0084715 A1
(43) Pub. Date: Mar. 27, 2014

(54) Switched Reluctance Motor

(71) Applicant: Defang Yuan, Ottawa (CA)

(72) Inventor: Defang Yuan, Ottawa (CA)

(21) Appl. No.: 13/626,027

(22) Filed: Sep. 25, 2012

(51) Int. Cl. H02K 1/24

(52) U.S. Cl. CPC H02K 1/246
USPC 310/46

(57) ABSTRACT

A switched reluctance motor (SRM) with a rotor shaft defining a rotational axis, a rotor disc extending radially from the rotor shaft, the rotor disc has rotor poles spaced equally circumferentially. The SRM also has a stator arrangement with member stators spaced equally circumferentially and aligned in a common plane perpendicular to the rotational axis and axially spaced from the rotor disc for forming an axial air gap. Every second member stator of the plurality of member stators forms a respective group, so that each member stator of a first group is surrounded by two members of a second group on each side. The stator coils in the first group are connected to a half-wave rectifier arrangement in a forward direction and the stator coils in the second group are connected to the half-wave rectifier arrangement in the reverse direction.

### BACKGROUND OF THE INVENTION

The present invention relates to an electric motor, and more specifically, to a switched reluctance motor.

Reluctance motors are well-known in the art. In general a reluctance motor is a type of electric motor that induces non-permanent magnetic poles on the rotor. Torque is generated through magnetic reluctance, i.e. by the tendency of the rotor to move to a position where the magnetic reluctance is minimal. One type of the reluctance motors is controlled by a circuitry. The circuitry determines the position of the rotor, and the windings of a phase are energized as a function of rotor position. This type of reluctance motor is generally referred to as a switched reluctance motor (SRM).

FIG. 1(A) shows a schematic perspective view of an SRM. The cylindrical stator 102 of the SRM includes multiple inward projecting electromagnet poles 104, 106. The poles protrude from the inner diameter of the stator and point toward the open center of the cylindrical stator. The stator is periodically magnetized by a magnetic field, produced by a flow of electric current in windings 112 that encircle the poles of the stator. Nested concentricity in the open center is a rotor 107 having outwardly projecting poles 108, 110. Typically, the rotor contains no circuitry or permanent magnets. The rotor and the stator are coaxial. The rotor may be made of soft magnetic material, such as laminated silicon steel, and has multiple projections 108, 110 acting as salient magnetic poles through magnetic reluctance. The rotor is connected to a rotor shaft 111 which is free to rotate and acts as an output shaft when the machine is motoring. Energizing of a stator causes a rotor pole to move into alignment with corresponding stator poles, thereby minimizing the reluctance of the magnetic flux path. Rotor position information may be used to control energizing of each phase to achieve smooth and continuous torque.

FIG. 1(B) is a schematic sectional view of the SRM. A coil 114 is provided at each stator pole 116. The stator poles 116, 118 which are positioned opposite one another may generally be coupled to form a single phase. A phase is energized by delivering current to the coil 114. Switching devices are generally provided which allow the coil to be alternately connected into a circuit which delivers current to the coil when the phase is energized and one which separates the coil from a current source when the phase is de-energized, and which may recover energy remaining in the winding.

When a rotor pole 120 is equidistant from the two adjacent stator poles 118, 122, the rotor pole 120 is in the fully unaligned position. This is the position of maximum magnetic reluctance for the rotor pole 120. In the aligned position, two or more rotor poles 124,126 are fully aligned with two or more stator poles 128, 130, and is a position of minimum reluctance.

Reluctance torque is developed in an SRM by energizing a pair of stator poles when a pair of rotor poles is in a position of misalignment with the energized stator poles. The rotor torque is in the direction that will reduce reluctance. Thus the nearest rotor pole is pulled from the unaligned position into alignment with the stator field i.e. a position of less reluctance. Energizing a pair of stator poles creates a magnetic north and south in the stator pole pair. Because the pair of rotor poles is misaligned with the energized stator poles, the reluctance of the stator and rotor is not at its minimum. The pair of rotor poles will tend to move to a position of minimum reluctance with the energized windings. The position of minimum reluctance occurs where the rotor and the energized stator poles are aligned.

In order to sustain rotation, the stator magnetic field must rotate in advance of the rotor poles, thus constantly pulling the rotor along. At a certain phase angle in the rotation of the rotor poles to the position of minimum reluctance, but near the position of minimum reluctance is achieved, the current is removed from the phase de-energizing the stator poles. Subsequently, or simultaneously, a second phase is energized, creating a new magnetic north and south pole in a second pair of stator poles. If the second phase is energized when the reluctance between the second pair of stator poles and the rotor poles is decreasing, positive torque is maintained and the rotation continues. Continuous rotation is developed by energizing and de-energizing the stator poles in this fashion. Some SRM variants may run on 3-phase AC power. Most modern designs are of the switched reluctance type, because electronic commutation gives significant control advantages for motor starting, speed control, and smooth operation.

SRMs may be grouped by the nature of the magnetic field path as to its direction with respect to the axis of the motor. If the magnetic field path is perpendicular to the axial shaft, which may also be seen as along the radius of the cylindrical stator and rotor, the SRM is considered as radial.

One problem associated with radial SRM is that the torque developed by the motor is not smooth. Torque drops off steeply when the phase angle of the rotor is between the poles of the stator, where the reluctance is at maximum, then increases as the phase angle of the rotor moves toward alignment with a stator pole, where the inductance is at maximum. This rising and falling torque phenomenon is known as “torque ripple”.

Another problem of the prior art SRM is that the torque developed by the motor is not sufficient at low speed which is desirable in many applications.

Another problem more prominently associated with radial SRM is noise and vibration. As the reluctance of the radial SRM increases and decreases, the magnetic flux in parts of the motor changes accordingly, and deforms the shape of the rotor and stator poles thereby decreasing the separation space between the poles, resulting in ovalizing of the stator, audible noise and unwanted vibration.

In an effort to overcome the above mentioned problems, other SRMs are designed to define the magnetic flux paths to be parallel to the rotational axis of the rotor, whereby the SRM is considered as axial. With the axial SRM designs, an upper U-shaped stator is arranged above the disc and a corresponding lower U-shaped stator is arranged below the disc. An air gap is formed between the poles of each stator pole and the disc. An air gap flux path between the two poles of the upper stator passes about the stator coil from one pole, through the disc, and through the other pole. Similarly, an air gap flux path between the two poles of the lower stator passes from one pole, through the disc, and to the other pole.

The problem of torque ripple may also be addressed by modifying the motor control circuitry, for example, by profiling the current in a phase during the active time period when the phase is energized, the rate of change in the magnetic flux can be controlled resulting in less abrupt changes in machine torque. This approach requires complex circuitry, and therefore results in higher design, manufacturing, and maintenance costs. A general description of the operation principle of SRM may be found at http://services.eng.uts.edu.au/cempe/subjects_JGZ/eet/EET_Switched%20Reluctance%20Motor_JGZ_{—}7_{—}3_{—}05.pdf, the content of which is incorporated herein by reference. Often, in order to reduce the torque ripple, complex simulation, such as described in http://www.planet-rt.com/technical-document/real-time-simulation-and-control-reluctance-motor-drives-high-speed-operation, is needed. This will further result in complex implementation of the control circuitry.

Therefore, there is a need to a low torque ripple SRM which is easy to manufacture and easy to control. There is a further need to a high torque SRM at low speed. There is a further need to a low torque ripple SRM which can use a common 3-phase AC supply or a simple control circuitry. There is yet a further need for an SRM with flexible numbers of stators and rotors.

### SUMMARY OF THE INVENTION

According to one aspect of the present invention there is provided a switched reluctance motor. The switched reluctance motor comprises a rotor shaft defining a rotational axis. A rotor disc extends radially from the rotor shaft. The rotor disc has a first plurality of rotor poles spaced equally circumferentially. The switched reluctance motor further comprises a stator arrangement having a second plurality of member stators. The member stators are spaced equally circumferentially. The member stators are aligned in a common plane perpendicular to the rotational axis and axially spaced from the rotor disc for forming an axial air gap. Each of the member stators has a stator coil providing a magnetic flux in the axial air gap when energized. The magnetic flux in the axial air gap is parallel to the rotational axis. Every second member stator of the second plurality of member stators forms a respective group, resulting in a first group and a second group of member stators. Each member stator of the first group is surrounded by two members of the second group on each side. The switched reluctance motor further comprises a control circuitry comprising a half-wave rectifier arrangement in a forward direction and a half-wave rectifier arrangement in a reverse direction. The stator coils in the first group are connected to the half-wave rectifier arrangement in the forward direction and the stator coils in the second group are connected to the half-wave rectifier arrangement in the reverse direction.

According to another aspect of the present invention there is provided a switched reluctance motor. The switched reluctance motor comprises a rotor shaft defining a rotational axis and a rotor disc ring connected to the rotor shaft. The rotor disc ring has a first plurality of rotor poles spaced equally circumferentially. The switched reluctance motor further comprises a stator arrangement having a second plurality of member stators. The member stators are spaced equally circumferentially. The member stators are aligned in a common plane perpendicular to the rotational axis and axially spaced from the rotor disc for forming an axial air gap. Each of the member stators has a stator coil providing a magnetic flux in the axial air gap when energized. The magnetic flux in the axial air gap is parallel to the rotational axis. Every second member stator of the second plurality of member stators forms a respective group, resulting in a first group and a second group of member stators. Each member stator of the first group is surrounded by two members of the second group on each side. The switched reluctance motor further comprises a control circuitry comprising a half-wave rectifier arrangement in a forward direction and a half-wave rectifier arrangement in a reverse direction. The stator coils in the first group are connected to the half-wave rectifier arrangement in the forward direction and the stator coils in the second group are connected to the half-wave rectifier arrangement in the reverse direction.

Preferably, the rotor disc is a first rotor disc and the stator arrangement is a first stator arrangement, the switched reluctance motor further comprises: a second rotor disc and a third rotor disc, each extending radially from the rotor shaft, the second rotor disc and the third rotor disc having the first plurality of rotor poles spaced equally circumferentially; and a second stator arrangement and a third stator arrangement, each having an identical configuration as the first stator arrangement. The control circuitry further comprises two half-wave rectifier arrangements in a forward direction and two half-wave rectifier arrangements in a reverse direction. The stator coils in each of the first groups are connected to the half-wave rectifier arrangement in the forward direction and the stator coils in each of the second groups are connected to the half-wave rectifier arrangement in the reverse direction. Two adjacent member stators define a stator sector angle and two adjacent rotor poles define a rotor sector angle.

Preferably, the second rotor disc is indexed relative to the first rotor disc, and the third rotor disc is indexed relative to the second rotor disc.

Preferably, the second stator arrangement is indexed relative to the first stator arrangement, and the third stator arrangement is indexed relative to the second stator arrangement.

Preferably, the second rotor disc is indexed by a third of the rotor sector angle relative to the first rotor disc, and the third rotor disc is indexed by a third of the rotor sector angle relative to the second rotor disc.

Preferably, the second stator arrangement is indexed by a third of the rotor sector angle relative to the first stator arrangement, and the third stator arrangement is indexed by a third of the rotor sector angle relative to the second stator arrangement.

Preferably, the second rotor disc is indexed one sixth of the rotor sector angle relative to the first rotor disc, and the third rotor disc is indexed one sixth of the rotor sector angle to the second rotor disc.

Preferably, the second stator arrangement is indexed one sixth of the rotor sector angle relative to the first stator arrangement, and the third stator arrangement is indexed one sixth of the rotor sector angle to the second stator arrangement.

Preferably, the first plurality is half of the second plurality.

Preferably, each of the member stators has a C-shaped core and a back portion of the C-shaped core forms an air gap.

Preferably, the rotor pole is made from material selected from the group consisting of iron, steel including electrical steel and silicon steel, ferrite, amorphous magnetic, and perm alloy.

Preferably, the rotor disc is made from material selected from the group consisting of aluminum, titanium, steels, iron, plastics including fiber-reinforced plastics, and ceramic.

Preferably, the stator coils of the member stators in one of the first and second groups are connected in series or in parallel.

Preferably, the switched reluctance motor is powered by a three-phase AC.

According to another aspect of the present invention there is provided a method for generating torque by a switched reluctance motor, the method comprising: defining a rotational axis in a rotor shaft of the switched reluctance motor; arranging a rotor disc with the rotor shaft, the rotor disc extending radially from the rotor shaft; inserting a first plurality of rotor poles spaced equally circumferentially into the rotor disc; arranging equally circumferentially a second plurality of member stators; the second plurality of member stators spaced; aligning the member stators in a common plane perpendicular to the rotational axis and axially spaced from the rotor disc for forming an axial air gap; each of the member stators having a stator coil; grouping every second member stator of the second plurality of member stators to form a first group and a second group of member stators, and each member stator of the first group is surrounded by two members of the second group on each side; and providing a control circuitry comprising a half-wave rectifier arrangement in a forward direction and a half-wave rectifier arrangement in a reverse direction, connecting the stator coils in the first group to the half-wave rectifier arrangement in the forward direction; connecting the stator coils in the second group to the half-wave rectifier arrangement in the reverse direction; and energizing the control circuitry and the stator coil to provide a magnetic flux in the axial air gap, the magnetic flux in the axial air gap being parallel to the rotational axis.

Preferably, the method further comprises: arranging a second rotor disc and a third rotor disc, each extending radially from the rotor shaft; inserting a first plurality of rotor poles spaced equally circumferentially into the second rotor disc and the third rotor disc; and arranging a second stator arrangement and a third stator arrangement, each have an identical configuration as the first stator arrangement; wherein the control circuitry further comprises two half-wave rectifier arrangements in a forward direction and two half-wave rectifier arrangements in a reverse direction; wherein the stator coils in each of the first groups are connected to the half-wave rectifier arrangement in the forward direction and the stator coils in each of the second groups are connected to the half-wave rectifier arrangement in the reverse direction.

Preferably, the second stator arrangement is indexed relative to the first stator arrangement, and the third stator arrangement is indexed relative to the second stator arrangement.

Preferably, the second rotor disc is indexed by a third of the rotor sector angle relative to the first rotor disc, and the third rotor disc is indexed by a third of the rotor sector angle relative to the second rotor disc.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1(A) is a partial perspective view of a prior art radial SRM;

FIG. 1(B) is a sectional view of the prior art radial SRM of FIG. 1(A);

FIG. 2(A) is a partial perspective view of the SRM in accordance with one embodiment of the present invention;

FIG. 2(B) is a partial view of a rotor and a member stator in the SRM in accordance with one embodiment of the present invention;

FIG. 2(C) is a sectional view of a rotor and a member stator in the SRM in accordance with one embodiment of the present invention;

FIG. 3(A) is a schematic view of a stator arrangement in accordance with one embodiment of the present invention;

FIG. 3(B) is a schematic view of an exemplary rotor for use with the stator arrangement of FIG. 3(A);

FIG. 3(C) is a schematic view of the stator arrangement of FIG. 3(A) and the rotor of FIG. 3(B);

FIG. 4 shows a power converter which can be used to operate the axial SRM in accordance with one embodiment of the present invention;

FIG. 5(A) is a schematic view of an SRM in accordance with another embodiment of the present invention;

FIG. 5(B) is a schematic view of an SRM in accordance with another embodiment of the present invention;

FIG. 5(C) illustrates a 3-phase, 48-stator arrangement in accordance with another embodiment of the present invention;

FIG. 5(D) illustrates schematically a 6-phase 48-stator SRM in accordance with another o embodiment of the present invention;

FIG. 6(A) shows a star connection power converter for use with a three-phase SRM in accordance with one embodiment of the present invention;

FIG. 6(B) shows a delta connection power converter for use with a three-phase SRM in accordance with one embodiment of the present invention;

FIG. 7(A) shows a commercial sinusoidal power supply wave form;

FIG. 7(B) shows the positive part of an irregular shaped wave form for minimizing a torque ripple;

FIG. 7(C) depicts a three-phase power inverter;

FIG. 7(D) shows a three-phase shaped wave form for minimizing a torque ripple;

FIG. 8 shows an arrangement of stators inside a ring-shaped rotor; and

FIGS. 9(A) and (B) illustrate an embodiment where the stators are in a linear arrangement.

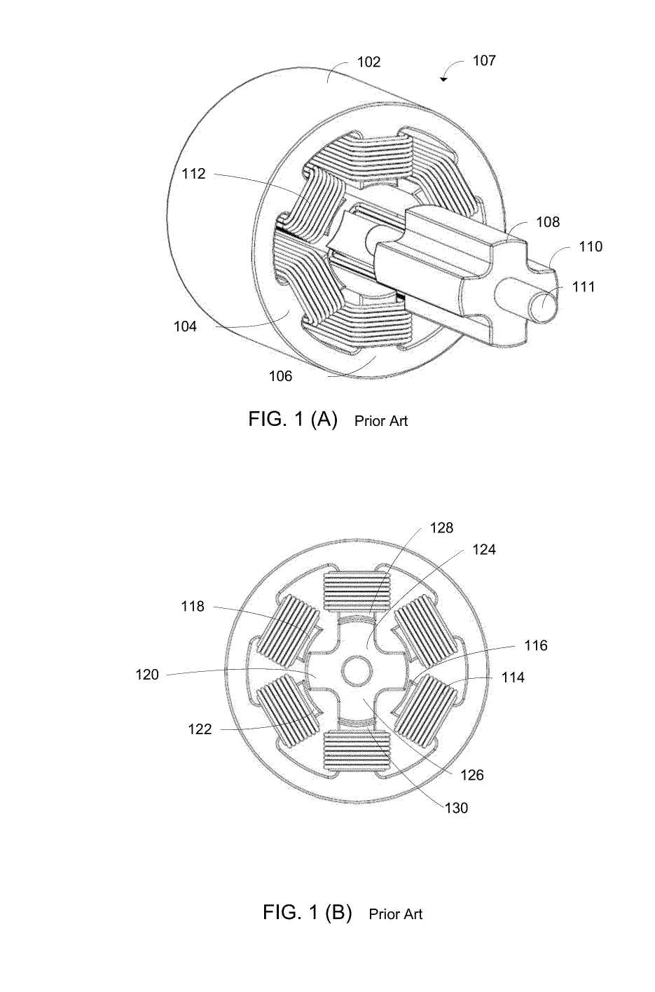

### DETAILED DESCRIPTION OF PREFERRED EMBODIMENTS

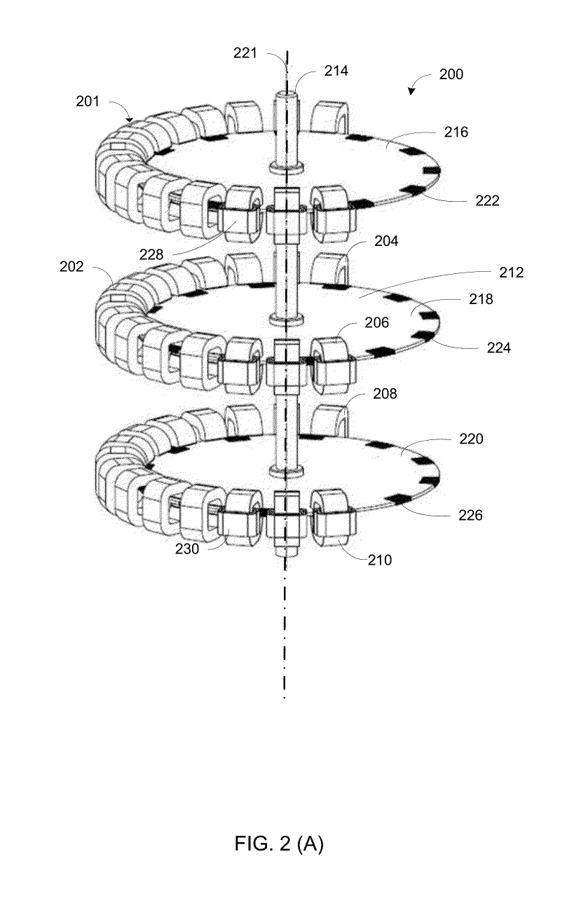

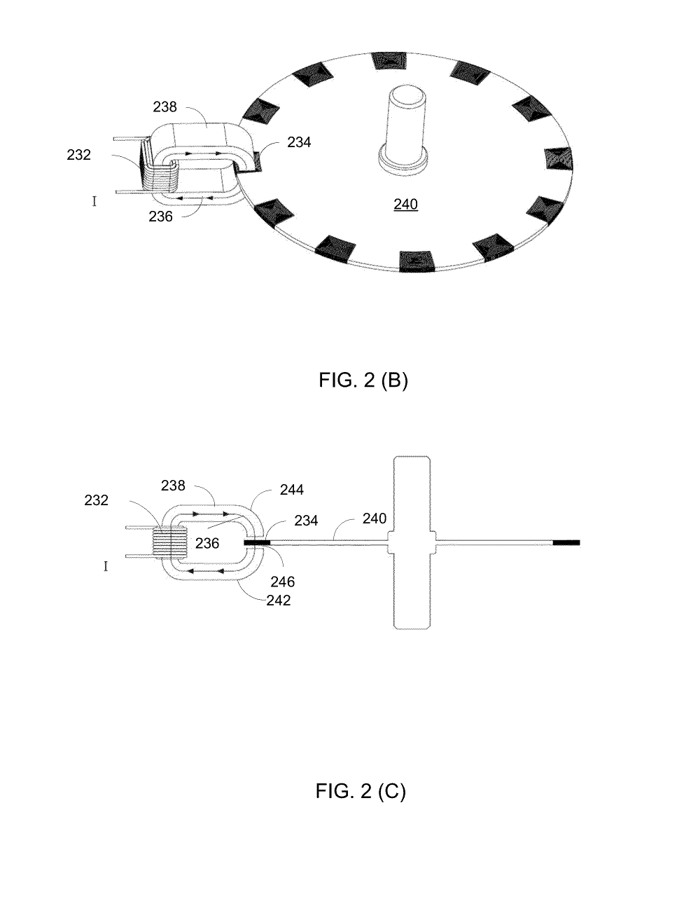

Referring to FIG. 2(A), a three-phase axial SRM 200 in accordance with one embodiment of the present invention is illustrated. The principal components of the SRM 200 include a stator arrangement 201 with a plurality of “C”-shaped member stators 202, 204, 206, 208 and 210; and a rotor 212 comprising a rotor shaft 214 and three radially extending rotor discs 216, 218, 220. The central longitudinal axis 221 of rotor shaft 214 is considered the rotational axis of the rotor 212. Each of the rotor discs 216, 218, 220 has a plurality of rotor poles 222, 224, 226.

The “C”-shaped member stators 202, 204, 206, 208, 210 are axially spaced from the rotor discs 216, 218, 220 and rotor poles 222, 224, 226 for forming axial air gaps. For each of the rotor discs, for example, rotor disc 218, the associated “C”-shaped member stators 204, 206 are aligned in a common plane perpendicular to the axis 221. As described below, the stator poles are also equally-spaced circumferentially by a common predetermined stator sector angle, resulting in the equally circumferential spacing of the member stators.

Each of the member stators 202, 204, 206, 208, 210 in the stator arrangement is an electromagnet with a C-shaped core and a stator coil 228, 230. Also referring to FIGS. 2(B) and 2(C), when a stator coil 232 is energized, a magnetic flux 236 is generated within the C-shaped core and emerges from a back iron portion 242, 244 to interact with the rotor pole 234 and extends to the magnetic flux 236 between the gap of the stator 238 and the rotor pole 234. The orientation of the magnetic flux 236 extending from the stator 238 and through the rotor poles 234 is axial, parallel to the rotor shaft 214. The magnetic flux 236 through air gap 246 is shortened, that is, much shorter than in a conventional SRM, thus the magnetic flux 236 remains mainly in the gap 246, and extending only through the back iron portion 242, 244 of the member stator pole 238 equivalent to about the axial thickness of the rotor disc 240. Generally, a coil 232 for a phase is switched on and off, firstly to capture a rotor pole 234 of the respective rotor disc 240 in its magnetic field when on, and the phase is turned off when the rotor pole is or is about fully aligned with certain member stator. Using predetermined switching of the phases to actuate the appropriate stator coil for the corresponding rotor disc, the desired rotor speed is achieved, as is control of forward or reverse rotation.

The rotor pole 234 can be configured such that the magnetic flux 236 through pole 234 is radially balanced, that is, there is no radially attractive and repulsive forces across the rotor disc towards the shaft. This arrangement substantially eliminates the noise, vibration and deformation of the motor due to the elimination of radial forces in conventional SRM.

Advantageously, the individual, short magnetic flux path of the member stators reduces the magnetic leakage, thus increases the effectiveness of the stator arrangement. Less leakage enables closer positioning of stator poles, this means higher count of stator poles are practically possible, higher count of stator poles are difficult to implement with prior art radial SRM technology due to magnetic leakage affections. The higher count of stator poles in turn increases the torque of the SRM, and reduces the speed of the SRM. In some embodiments, no additional mechanical gear is needed to reduce the speed of the output. In operation, the short magnetic flux path further results in energy savings.

Advantageously, the individual member stators generally have the same configuration, and are more compact than the member stators in the prior art radial SRM. Therefore, the stator arrangement as illustrated in FIG. 2(A) is easy to manufacture, reduces manufacture material and cost, and can be assembled by automation.

Advantageously, the manufacture of the rotor poles may be further simplified by inserting the rotor poles into the rotor disc, thereby reducing the use of the magnetic material.

Advantageously, the working magnetic flux path only passes the poles of the rotor, not necessarily the disc body. There is a variety of non-magnetic materials suitable for use as the rotor disc, with the rotor poles imbedded in the rotor disc. Magnetic materials suitable for magnetic poles of the rotor may include, but not limited to, iron, steel including electrical steel, ferrite, amorphous magnetic, perm alloy. Preferably, the magnetic poles are made of ferromagnetic material, such as motor iron, silicon steel. Non-magnetic materials suitable for rotor discs may include, but not limited to, aluminum, titanium, many stainless steels, plastics including fiber-reinforced plastics, ceramic, carbon-fiber. Preferably, the rotor discs are made of cast aluminum, cast iron, steel, plastic, The term “non-magnetic material” is intended to describe a material that is generally not susceptible to magnetic fields. The term “magnetic material” refers to materials that are susceptible to magnetic fields. Generally, the ferromagnetic nature of the magnetic material only appears after an external magnetic field is applied.

Advantageously, the member stators in a stator arrangement may be controlled individually, or in groups, as will be described in more detail below.

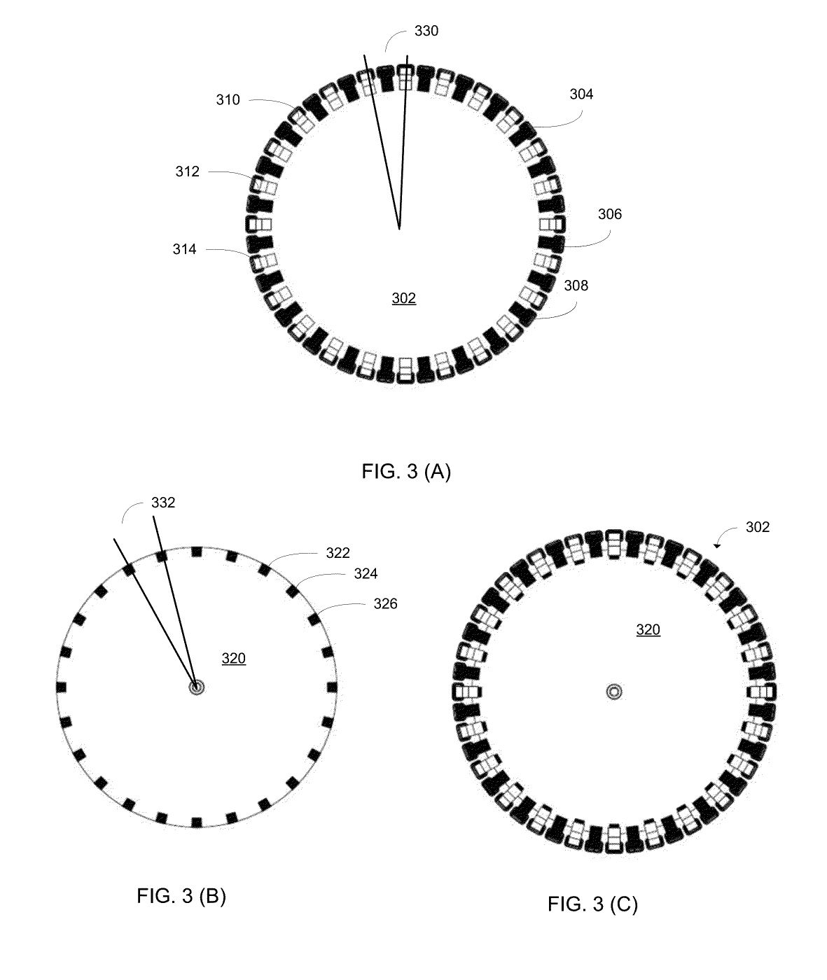

FIG. 3(A) is a schematic view of a stator arrangement 302 in accordance with one embodiment of the present invention. In the illustrated example, the stator arrangement 302 has 48 member stators 304, 306, 308, 310, 312, 314. The member stators are divided into two groups of 24 member stators each, as depicted by the black and white squares, respectively, in the illustrated embodiment, group A is depicted in white and group B is depicted in black. The member stators are equally-spaced circumferentially by a predetermined stator sector angle, in this example 7.5°, with each member stator of the first group, e.g. group A, 304, 306, 308 surrounded by two member stators of the second group, e.g. group B, 310, 312, 314 on each side. Each member stator of the first or second group has therefore a predetermined group sector angle, in this example 15°, with the next member of the same group.

The member stators of the first group (group A) 304, 306, 308 may be connected in any fashion provided that the current flowing through each coil of the member stators is the same. Likewise, the member stators of the second group (group B) 310, 312, 314 may be connected together in any fashion provided that the current flowing through each coil of the member stators is the same. In other words, the member stators of the respective groups may be connected in series, in parallel or in a combination of serial and parallel connections.

FIG. 3(B) is an exemplary rotor 320 for use with the stator arrangement 302 of FIG. 3(A). The rotor disc 320 supports 24 rotor poles 322, 324, 326, which are equally spaced-apart circumferentially by a predetermined rotor sector angle, in this example 15°, associated with the spacing of the member stators of the stator arrangement 302.

FIG. 3(C) is a schematic view of the stator arrangement 302 with the rotor 320, where the relationship between the member stators of the stator arrangement 302 and the rotor poles of the rotor 320 is illustrated. The number of member stators in one group may correspond to the number of rotor poles of the rotor 320, i.e. the group sector angles between the member stators of one group of the stator arrangement 330 and the rotor poles of the rotor 332 are the same. The group sector angle of the member stators and the rotor poles ensures that during each rotation of the rotor disc 320 the member stators of one group and the rotor poles simultaneously register. This registration occurs repeatedly during each revolution, namely forty eight (48) times in FIG. 3(C) corresponding to the total number of the member stators and the number of rotor poles. As rotor poles register with the member stators, the coils associated with the member stators of that group will be energized electrically just as the rotor poles near the air gaps of the member stators, to produce a motor torque and would be de-energized prior to reaching the fully registered state. The large number of the rotor poles and the member stators of a group permits generation of fairly substantial torques even at low speeds or at start-up.

Referring to FIGS. 2(B) and 3(C), the arrangement of the member stators in a group and rotor poles results in the formation of local magnetic flux paths between each of the member stators 238 and the rotor poles 234. Referring to FIG. 2(C), a local magnetic flux path 236 associated with a member stator 238 is shown. The magnetic flux path comprises the two poles 242, 244 and the rotor disk 240. The rotor pole 234 is magnetically attracted by adjoining poles 242, 244. The rotor disc 240 does not contribute to the working magnetic flux path directly, so the rotor disc 240 can therefore be formed of a light-weight non-magnetic material such as aluminum, plastic or any other suitable material. The formation of localized magnetic circuits minimizes the length of required magnetic paths thereby reducing power losses. The rotor poles are constructed of a multiplicity of identical magnetic material, for example but not limited to, motor iron. During assembly, the rotor poles may be simply inserted or embedded into the rotor disc 240.

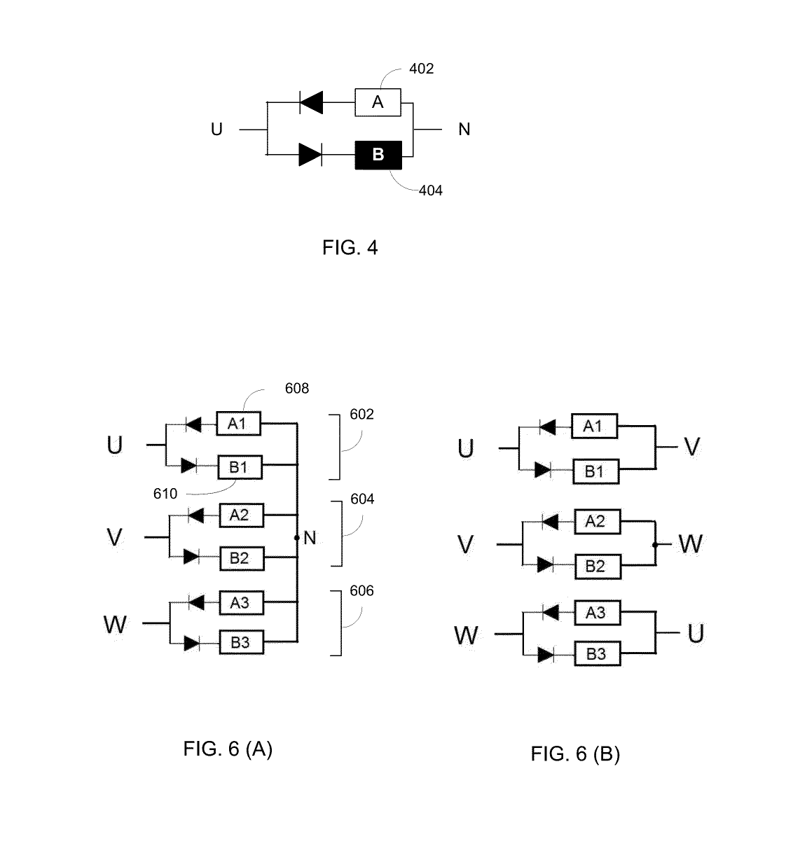

Referring to FIG. 3(A), the member stators of the stator arrangement 302 are alternately connected to two groups, group A and group B. FIG. 4 shows a power converter control circuitry which can be used to operate the axial SRM in accordance with one embodiment of the present invention. The control circuitry is shown in association with two groups, A and B, of the member stators in the stator arrangement 302 as 402 and 404, respectively. Group A 402 of the member stators are connected to a half-wave rectifier arrangement in a reverse direction while group B 404 of the member stators are connected to a second half-wave rectifier arrangement in a forward direction. The terminal U is connected to a single phase AC. In operation, the positive half of the single phase AC wave passes through the group B 404 of the member stators. The negative half of the single phase AC wave passes through the group A 402 of the member stators. Advantageously, the coils in the group A of the member stators and the coils in the group B of the member stators are energized in sequence, and in synchronization with the phase of the single phase AC. This produces a moving magnetic field which induces torque through adjacent rotor poles. The rotor disc rotates to move adjacent rotor poles inline with the energized member stator for minimizing the flux path. Advantageously, both the positive half and the negative half of the single phase AC wave contribute to the operation of the axial SRM of the present invention. Advantageously, referring to FIGS. 3(A) and 3(C), since twenty-four member stators are energized at the same time, a substantial starting torque can be developed.

Advantageously, the axial magnetic flux path is much shorter than prior art motors requiring less electrical steel. The rotor disc embodiment also requires less copper coil due to the elimination of conventional end connectors. Magnetic force is balanced radially, thus eliminating radial vibration. Less steel and less copper coils result in smaller, lighter, cooler and less expensive motors. The working magnetic flux path is purely axial, there is no component needed to conduct circumferential magnetic flux.

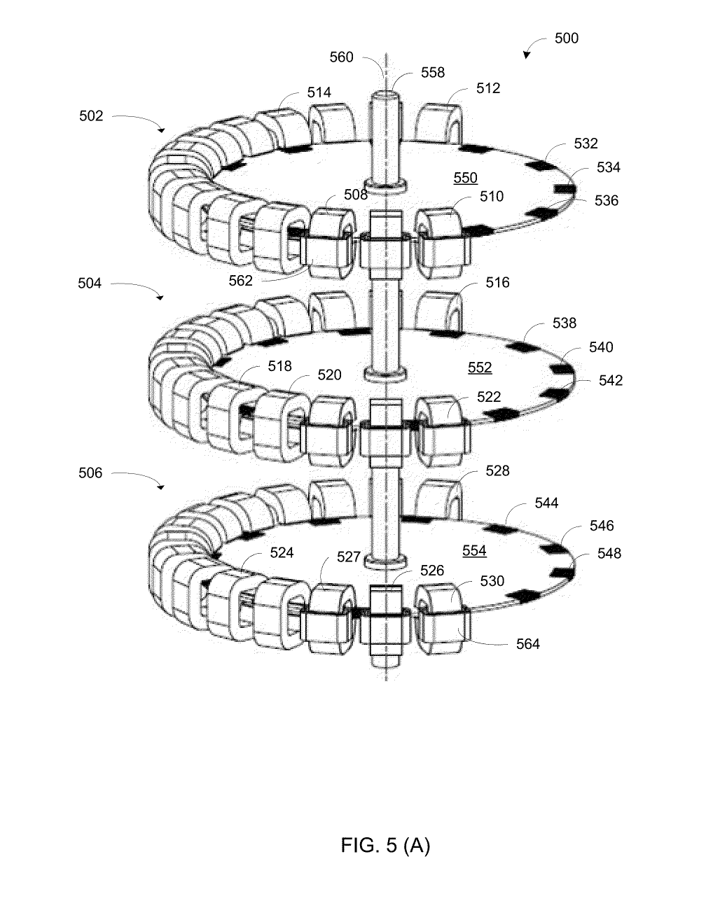

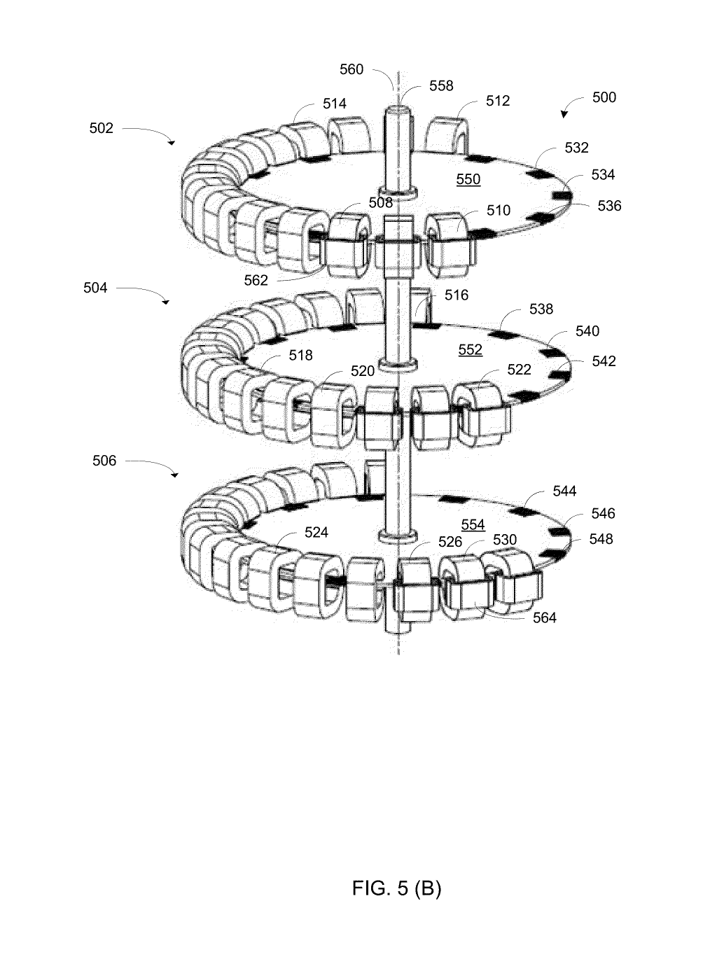

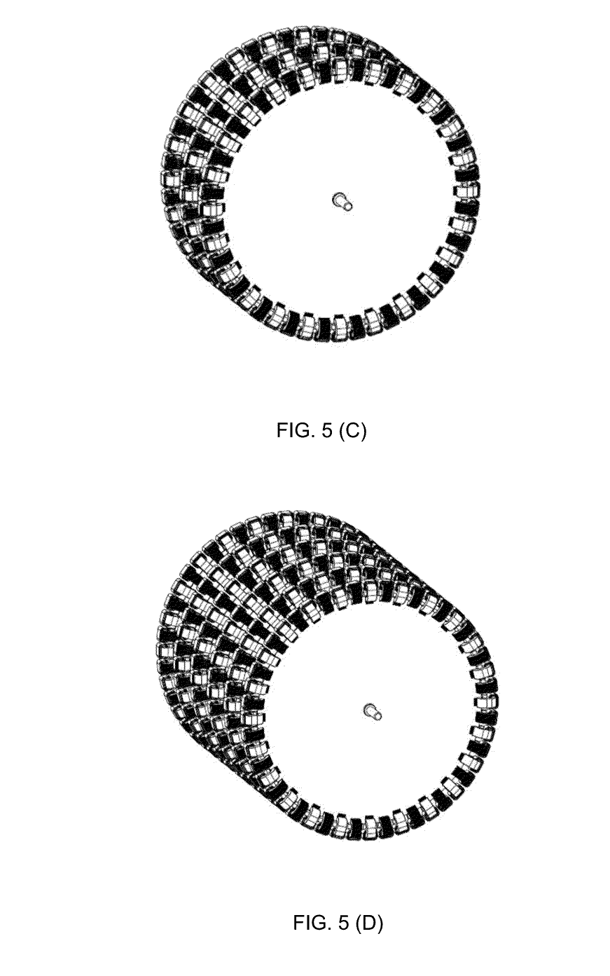

The stator arrangement 302 and the rotor disc 320 can also be used in a poly-phase SRM, preferably, in a three-phase SRM, as illustrated in FIG. 5(A). The use of multiple rotor discs conveniently enables multiple phases to be employed wherein one phase influences one rotor disc, wherein half of the member stators for that rotor disc are energized at once. For the purpose of a simplified three dimensional illustration, only 24 member stators and 12 rotor poles are shown in FIGS. 5(A) and 5(B). Similar to the arrangement described in FIG. 3(A), the member stators of the stator arrangements 502, 504, 506 are alternately connected to two groups, group A and group B. In other words, each member stator 526 in the first group is surrounded by member stators 527, 530 of the second group. The member stators are equally-spaced circumferentially and define a common predetermined stator sector angle, the stator sector angle in the exemplary embodiment in FIG. 5(A) is 15°. The group sector angle between the consecutive member stators in the same group is 30°. The rotor poles are also equally-spaced circumferentially by another common predetermined sector angle, the rotor sector angle in the exemplary embodiment in FIG. 5(A) is 30°.

The SRM 500 includes three stator arrangements 502, 504, 506. Each of the stator arrangements 502, 504, 506 includes 24 “C”-shaped member stators 508-530. Each stator arrangement engages a rotor disc with 12 rotor poles 532-548. For the purpose of better illustration, only those components necessary to understand the operation of the SRM have been illustrated, some of the member stators are removed to expose the rotor poles, and some of the stator coils are not shown. Three radially extending rotor discs 550, 552, 554, and a rotor shaft 558 form a rotor. The central longitudinal axis 560 of rotor shaft 558 is considered the rotational axis of the rotor.

For each of the rotor discs, for example, rotor disc 550, the associated “C”-shaped member stators 508, 510, 512, 514 are aligned in a common hypothetical plane perpendicular to the axis 560. Each of the member stators 508-530 has a stator coil 562, 564. For the purpose of better illustration, stator coils are not shown on some member stators 514, 518, 524. The stator arrangements of the second and third phases are similarly configured. It is apparent that one stator arrangement of each phase is axially aligned with a stator arrangement of either of the other two phases. The stator arrangements, 502, 504, 506, respectively corresponding to the first, second and third phases of a three-phase power supply, are exemplary of this axial alignment.

Each rotor disc of the three radially extending rotor discs 550, 552, 554, may be offset relative to previous rotor disc by an indexed angle.

In the illustrated example in FIG. 5(A), rotor disc 552 is offset or indexed relative to the rotor disc 550 by one-third of the rotor sector angle, i.e. 10°. Every second member stator of the stator arrangement 502 is fully registered with one of the rotor poles of the rotor disc 550. The rotor poles of the rotor disc 552 are indexed count-clockwise by 10°, and the rotor poles of the rotor disc 554 are indexed count-clockwise by an additional 10°, in other words, the rotor poles of the rotor disc 554 are indexed relative to the rotor disc 550 by two-thirds of the rotor sector angle, namely, 20°. The result is that the rotor poles of one of the rotor discs 550, 552, 554, are positioned for generation of torque tending to rotate the rotor shaft 558 forward if the coils associated with the particular phase are energized. In general, a rotor disc represents a different phase and the angular starting position of each rotor pole is angularly offset or indexed. Each rotor disc is secured to the rotor shaft 558 to maintain the rotationally indexed offset between the different phased stator arrangements 502, 504, 506.

In a second exemplary embodiment, as illustrated in FIG. 5(B), the three stator arrangements 502, 504, 506 may also be offset relative to each other.

In this embodiment, stator arrangement 502 is indexed relative to stator arrangement 504 by one-third of the rotor sector angle, i.e. 10°. Every second member stator of the stator arrangement 502 is fully registered with one of the rotor poles of the rotor disc 550. The member stators of the stator arrangement 504 are indexed clockwise by 10°, and the member stators of the stator arrangement 506 are indexed clockwise by an additional 10°, in other words, the member stators of the stator arrangement 506 are indexed by 20°. The result is that the rotor poles of one of the rotor discs 550, 552, 554, are positioned for generation of torque tending to rotate the rotor shaft 558 forward if the coils associated with the particular phase are energized.

In general, in a poly-phase SRM, for example, in the three-phase SRMs as described in FIGS. 5(A) and 5(B), the rotor discs may be adapted to be offset or indexed relative to the other rotor discs. Independently, the stator arrangements may be adapted to be offset or indexed relative to the other stator arrangements. Accordingly, at any given time, the member stators and rotor poles of at least one phase will be oriented for production of a forward torque when the associated coils are energized, or the total torque of the poly-phase SRM is a steady working torque.

Due to the compact size of the C-shaped member stators in the stator arrangement, more member stators can be used than the prior art SRM. In FIG. 5(C), a three-phase SRM with 48 member stators, 24 rotor-poles for each phase is depicted.

According to embodiments of the present invention, the number of rotor poles may be any integer number, the member stators may be any even numbers. The stator arrangement and the rotor disc embody modular construction principles, therefore, more stator discs can be added to the axial SRM of the present invention. FIG. 5(D) illustrates schematically a 6-phase 48-stator SRM in accordance with one embodiment of the present invention. In this example, the offset indexes for both rotor and stator, may be 1/6 of the rotor sector angle. The offset indexes result in a different torque pattern. Basically, an SRM can be built or an existing SRM of this construction can be expanded by adding additional rotor discs and stator arrangements so that required torque is achieved. The many possible permutations between the offsets stator arrangements and the rotor discs can provide the desired torque characteristics which otherwise may be difficult to achieve or can only be achieved with complex control logic.

Advantageously, the three-phase SRMs as described in FIGS. 5(A) and 5(B) may be driven by a simple star connection power converter described in FIG. 6(A). or a delta connection power converter in FIG. 6(B).

The basic single-phase power converter control circuitry described in FIG. 4, may be further connected in a star connection, as described in FIG. 6(A). The circuitry can be divided into three phase groups 602, 604, 606, in association with the exemplar embodiments of FIGS. 5(A) and 5(B). Each of the phase groups 602, 604, 606 is shown in association with two groups, A1 and B1, A2 and B2, A3 and B3, of the member stators in the stator arrangement 502, 504, 506, respectively. The connection U, V and W are connected to each of the phases of a three-phase power supply. Group A1 608 of member stators are connected to a half-wave rectifier arrangement in a reverse direction while group B1 610 of member stators are connected to a second half-wave rectifier arrangement in a forward direction. The same arrangement is provided for half-wave rectifier arrangements connected to V and W. In operation, the positive half of the phase U wave passes through the group B1 610 of member stators. The negative half of the phase U wave passes through the group A1 608 of member stators.

Advantageously, the coils in the group A1 member stators and the coils in the group B1 member stators are energized in sequence, and in synchronization with the phase U of the three phase AC. Likewise, the coils in group A2 member stators and the coils in the group B2 member stators are energized in sequence, and in synchronization with the phase V of the three phase AC, and the coils in the group A3 member stators and the coils in the group B3 member stators are energized in sequence, and in synchronization with the phase W of the three phase AC. Advantageously, both the positive half and the negative half of AC wave contribute to the operation of the axial SRM of the present invention. Accordingly, as show in FIG. 5(A), a 3-phase 24-stator-pole, 12-rotor-pole SRM, member stators can be energized a total of twenty-four times during each revolution to generate motor torque.

FIG. 6(B) shows an alternate power converter, with three basic single-phase power converter control circuitries described in FIG. 4, in a delta configuration suitable for the axial SRM of the present invention. As discussed, the member stators of a stator arrangement may be connected in different configurations, provided that the current through the coils of the member stators of the respective groups is the same. The coils of the member stators may be, for example, connected in series. The power converter FIG. 6(B) provides higher peak-to-peak voltages, therefore, it may be suitable for driving member stators arranged in series.

Referring to FIGS. 3(A)-3(B) and 5(A)-5(B), since twelve or twenty-four member stators are energized at the same time, a substantial starting torque can be advantageously developed.

Advantageously, through the adjusting of the index angle of the rotor discs and the index angle of the stator arrangements of the poly-phase SRM, the torque ripple can be minimized or eliminated.

For example, for a three-phase SRM as described in FIG. 5(A), the index angle of the rotor discs and the index angle of the stator arrangements may be the 1/6, 2/6 . . . of the angles between the rotor poles. For a six-phase SRM as described in FIG. 5(D), the index angle of the rotor discs and the index angle of the stator arrangements may be the 1/12, 2/12 . . . of the angles between the rotor poles. In general, for a M-phase SRM, the index angle of the rotor discs and the index angle of the stator arrangements may be the 1/(2M), 2/(2M) . . . of the angles between the rotor poles.

Referring to FIG. 5(A), the torque T₁ generated by the first rotor disc 550 is

T₁=CT₁+RT₁(t)

wherein CT₁ is the constant torque generated by first rotor disc 550, and RT₁(t) is the variable torque at time t;

the torque T₂ generated by the second rotor disc 552 is

T₂=CT₂+RT₂(t)

wherein CT₂ is the constant torque generated by the second rotor disc 552, and RT₂(t) is the variable torque at time t;

the torque T₃ generated by the third rotor disc 554 is

T₃=CT₃+RT₃(t)

wherein CT₃ is the constant torque generated by the third rotor disc 554, and RT₃(t) is the variable torque at time t.

For a three-phase SRM as illustrated in FIG. 5(A), total torque T is:

T=T₁+T₂+T₃=CT₁+RT₁(t)+CT₂+RT₂(t)+CT₃+RT₃(t)

CT₁, CT₂ and CT₃ are constants. RT₁(t), RT₂(t) and RT₃(t) are time based variables.

RT₁(t), RT₂(t) and RT₃(t) may be controlled through both the indexing of the rotor discs and the stator arrangement, and combined with different control algorithms. It is therefore possible to minimize the amplitude in RT₁(t)+RT₂(t)+RT₃(t), and even to achieve the ideal result:

RT₁(t)+RT₂(t)+RT₃(t)=constant

For example, for a three-phase AC power supply, the power for

sin(χ)+sin(χ−2/3π)+sin(χ−4/3π) is constant,

For a three-phase triangle function f (χ), the power for

RT₁(t)+RT₂(t)+RT₃(t)=f(χ)+f(χ−2/3π)+f(χ−4/3π) is also constant

where: χ=2π f t

where: 2/3π=120° electrical phase angle, 4/3π=240° electrical phase angle in three-phase sinusoidal function sin (χ) and three-phase triangle function f (χ)

If T=T₁+T₂+T₃=CT₁+RT₁(t)+CT₂+RT₂(t)+CT₃+RT₃(t)=constant, that means there is no torque ripple

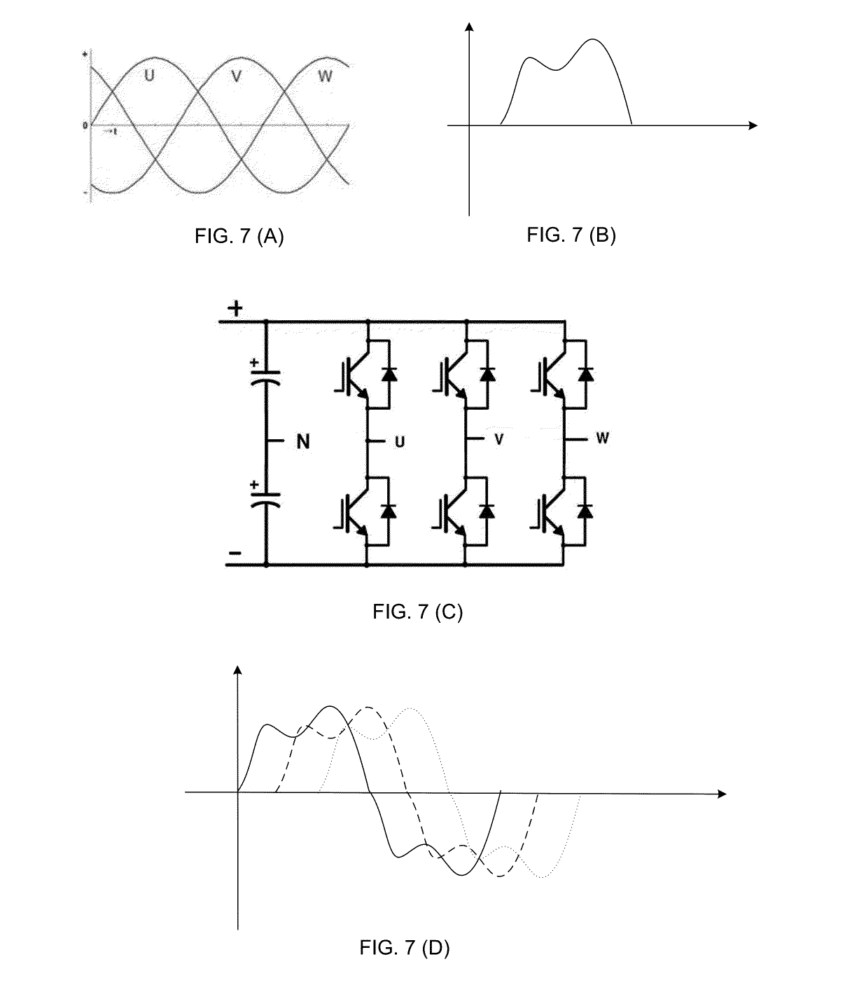

Referring to FIGS. 4, 5(A), 6(A) and 6(B), the provision of the stator in two groups and the arrangement of half-wave rectifiers in forward and reverse directions simplify the operation of the SRM, and have the advantage that both positive half and the negative half of the power supply contribute to the working torque of the SRM. A commercial power to drive the SRM, as illustrated in FIG. 7(A) may be used.

The stator coil current waveform to drive an SRM in accordance with an embodiment of the present invention, for example but not limited to, with a minimum torque ripple, may have an irregular shape instead of a sinusoidal shape, as illustrated in FIG. 7(D). A waveform may be considered as optimal when T=T₁+T₂+T₃=CT₁+RT₁(t)+CT₂+RT₂(t)+CT₃+RT₃(t) is constant.

A power inverter, for example, a three-phase power inverter as illustrated in FIG. 7(C) may be used to generate the three-phase optimal wave form as illustrated in FIG. 7(D) to power the SRM as illustrated in FIGS. 5(A) or 5(B). It should be apparent to a person skilled in the art that the both positive half and the negative half of the three-phase optimal wave form contribute to the operation working torque of the SRM.

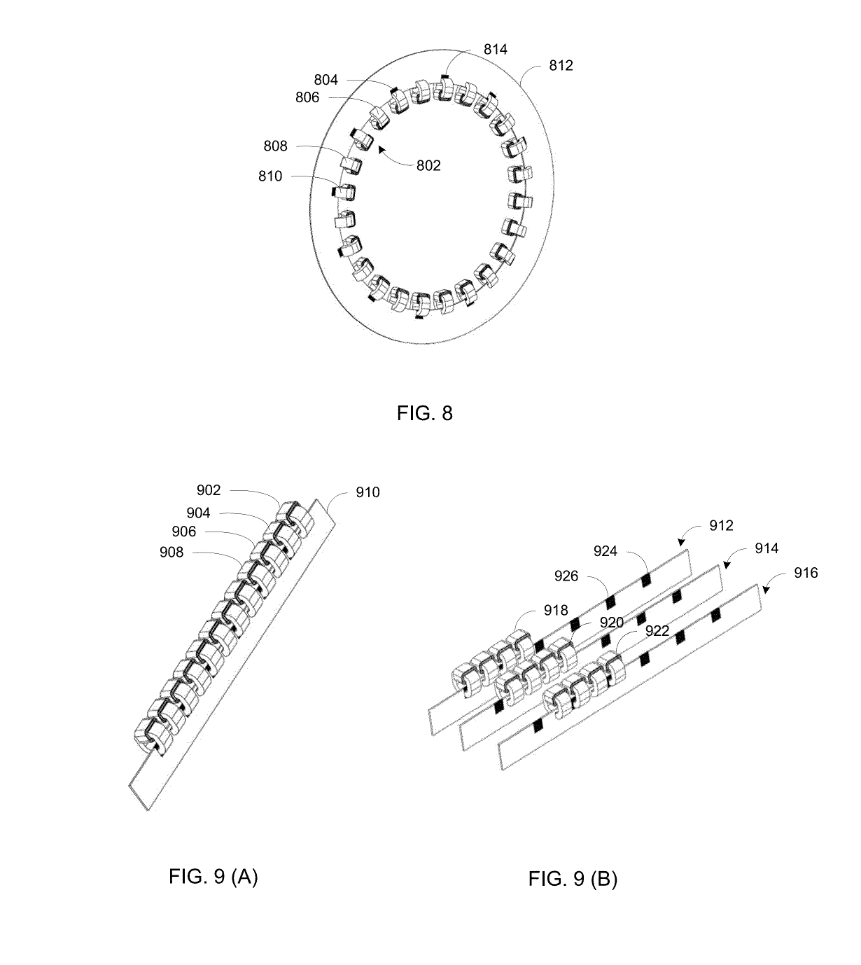

Other embodiments of the present invention include an arrangement of stators inside a ring-shaped rotor as illustrated in FIG. 8.

In the illustrated example, the stator arrangement 802 has 24 member stators 804, 806, 808, 810 arranged inside the ring-shaped rotor 812. In the illustrated embodiment, the ring-shaped rotor 812 has 12 rotor poles 814. The member stators may be divided into two groups of 12 member stators each, as indicated by 804, 810 and 806, 808, respectively. The member stators are equally-spaced circumferentially by a predetermined stator sector angle, in this example 15°, with each member stator of the first group, surrounded by two member stators of the second group on each side. Each member stator of the first or second group has therefore a predetermined group sector angle, in this example 30°, with the next member of the same group. Accordingly, each of the 12 rotor poles 814 also has the predetermined angle, in this example 30°, with the next rotor pole.

The member stators of the first group 804, 810 may be connected in any fashion provided that the current flowing through each coil of the member stators is the same. Likewise, the member stators of the second group 806, 808 may also be connected together in any fashion provided that the current flowing through each coil of the member stators is the same.

It should be apparent to a person skilled in the art that the arrangement described in FIG. 8 can also used in a multi-phase arrangement, analogous to the arrangement described in FIGS. 5(A) to 5(D).

It should be further apparent to a person skilled in the art that the connections described in FIGS. 4, 6(A) and 6(B) are non-limiting, preferred embodiments.

FIGS. 9(A) and (B) illustrate an embodiment where the stators are in a linear arrangement. The stators 902, 904, 906, 908 engage a rail, or slide way, 910 so that a linear movement can be initiated. The stators may also be divided into two groups, e.g. stators 902 and 906 in a first group and stators 904 and 908 in a second group. When the two groups are connected to the half-wave rectifier arrangement described in FIG. 4, the moving rail 910 moves forward in a linear fashion.

FIG. 9(B) shows a group of three-phase linear arrangements 912, 914, 916. Each of the stator arrangements 918, 920, 922 is offset to the other. It can also be seen that the distance between the poles 924, 926 on the rail is double the distance between the stators so that the poles interact with one group of the stators at a time. In the illustrated embodiment, the offset of stator 920 and 922 is preferably ⅓ or ⅔ of the distance between the poles on rail 910.

While the patent disclosure is described in conjunction with the specific embodiments, it will be understood that it is not intended to limit the patent disclosure to the described embodiments. On the contrary, it is intended to cover alternatives, modifications, and equivalents as may be included within the scope of the patent disclosure as defined by the appended claims. In the above description, numerous specific details are set forth in order to provide a thorough understanding of the present patent disclosure. The present patent disclosure may be practiced without some or all of these specific details. In other instances, well-known process operations have not been described in detail in order not to unnecessarily obscure the present patent disclosure.

The terminology used herein is for the purpose of describing particular embodiments only and is not intended to be limiting of the patent disclosure. As used herein, the singular forms “a”, “an” and “the” are intended to include the plural forms as well, unless the context clearly indicates otherwise. It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

It is further understood that the use of relational terms such as first and second, and the like, if any, are used solely to distinguish one from another entity, item, or action without necessarily requiring or implying any actual such relationship or order between such entities, items or actions.

An algorithm is generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

What is claimed is:

1. A switched reluctance motor comprising:
a rotor shaft defining a rotational axis;
a rotor disc extending radially from the rotor shaft, the rotor disc having a first plurality of rotor poles spaced equally circumferentially;
a stator arrangement having a second plurality of member stators; the second plurality of member stators spaced equally circumferentially; the member stators aligned in a common plane perpendicular to the rotational axis and axially spaced from the rotor disc for forming an axial air gap; each of the member stators having a stator coil providing a magnetic flux in the axial air gap when energized, the magnetic flux in the axial air gap being parallel to the rotational axis; every second member stator of the second plurality of member stators forming a respective group, resulting in a first group and a second group of member stators, and each member stator of the first group is surrounded by two members of the second group on each side; and
a control circuitry comprising a half-wave rectifier arrangement in a forward direction and a half-wave rectifier arrangement in a reverse direction;
wherein the stator coils in the first group are connected to the half-wave rectifier arrangement in the forward direction and the stator coils in the second group are connected to the half-wave rectifier arrangement in the reverse direction.

2. The switched reluctance motor of claim 1, wherein the rotor disc is a first rotor disc and the stator arrangement is a first stator arrangement, further comprising:
a second rotor disc and a third rotor disc, each extending radially from the rotor shaft, the second rotor disc and the third rotor disc having the first plurality of rotor poles spaced equally circumferentially; and
a second stator arrangement and a third stator arrangement, each having an identical configuration as the first stator arrangement;
wherein the control circuitry further comprises two half-wave rectifier arrangements in a forward direction and two half-wave rectifier arrangements in a reverse direction;
wherein the stator coils in each of the first groups are connected to the half-wave rectifier arrangement in the forward direction and the stator coils in each of the second groups are connected to the half-wave rectifier arrangement in the reverse direction; and
wherein two adjacent member stators define a stator sector angle and two adjacent rotor poles define a rotor sector angle.

3. The switched reluctance motor of claim 2, wherein the second rotor disc is indexed relative to the first rotor disc, and the third rotor disc is indexed relative to the second rotor disc.

4. The switched reluctance motor of claim 2, wherein the second stator arrangement is indexed relative to the first stator arrangement, and the third stator arrangement is indexed relative to the second stator arrangement.

5. The switched reluctance motor of claim 2, wherein the second rotor disc is indexed by a third of the rotor sector angle relative to the first rotor disc, and the third rotor disc is indexed by a third of the rotor sector angle relative to the second rotor disc.

6. The switched reluctance motor of claim 2, wherein the second stator arrangement is indexed by a third of the rotor sector angle relative to the first stator arrangement, and the third stator arrangement is indexed by a third of the rotor sector angle relative to the second stator arrangement.

7. The switched reluctance motor of claim 2, wherein the second rotor disc is indexed one sixth of the rotor sector angle relative to the first rotor disc, and the third rotor disc is indexed one sixth of the rotor sector angle to the second rotor disc.

8. The switched reluctance motor of claim 2, wherein the second stator arrangement is indexed one sixth of the rotor sector angle relative to the first stator arrangement, and the third stator arrangement is indexed one sixth of the rotor sector angle to the second stator arrangement.

9. The switched reluctance motor of claim 1, wherein the first plurality is half of the second plurality.

10. The switched reluctance motor of claim 1, wherein each of the member stators has a C-shaped core and wherein a back portion of the C-shaped core forms an air gap.

11. The switched reluctance motor of claim 1, wherein the rotor pole is made from material selected from the group consisting of iron, steel including electrical steel and silicon steel, ferrite, amorphous magnetic, and perm alloy.

12. The switched reluctance motor of claim 1, wherein the rotor disc is made from material selected from the group consisting of aluminum, titanium, steels, iron, plastics including fiber-reinforced plastics, and ceramic.

13. The switched reluctance motor of claim 1, wherein the stator coils of the member stators in one of the first and second groups are connected in series or in parallel.

14. The switched reluctance motor of claim 2, wherein the switched reluctance motor is powered by a three-phase AC.

15. A switched reluctance motor comprising:
a rotor shaft defining a rotational axis;
a rotor disc ring connected to the rotor shaft, the rotor disc ring having a first plurality of rotor poles spaced equally circumferentially;
a stator arrangement having a second plurality of member stators; the second plurality of member stators spaced equally circumferentially; the member stators aligned in a common plane perpendicular to the rotational axis and axially spaced from an in side of the rotor disc ring for forming an axial air gap; each of the member stators having a stator coil providing a magnetic flux in the axial air gap when energized, the magnetic flux in the axial air gap being parallel to the rotational axis; every second member stator of the second plurality of member stators forming a respective group, resulting in a first group and a second group of member stators, and each member stator of the first group is surrounded by two members of the second group on each side; and
a control circuitry comprising a half-wave rectifier arrangement in a forward direction and a half-wave rectifier arrangement in a reverse direction;
wherein the stator coils in the first group are connected to the half-wave rectifier arrangement in the forward direction and the stator coils in the second group are connected to the half-wave rectifier arrangement in the reverse direction.

16. The switched reluctance motor of claim 15, wherein each of the member stators has a C-shaped core and wherein a back portion of the C-shaped core forms an air gap.

17. A method for generating torque by a switched reluctance motor, the method comprising:
defining a rotational axis in a rotor shaft of the switched reluctance motor;
arranging a rotor disc with the rotor shaft, the rotor disc extending radially from the rotor shaft;
inserting a first plurality of rotor poles spaced equally circumferentially into the rotor disc;
arranging equally circumferentially a second plurality of member stators; the second plurality of member stators spaced;
aligning the member stators in a common plane perpendicular to the rotational axis and axially spaced from the rotor disc for forming an axial air gap; each of the member stators having a stator coil;
grouping every second member stator of the second plurality of member stators to form a first group and a second group of member stators, and each member stator of the first group is surrounded by two members of the second group on each side; and
providing a control circuitry comprising a half-wave rectifier arrangement in a forward direction and a half-wave rectifier arrangement in a reverse direction, connecting the stator coils in the first group to the half-wave rectifier arrangement in the forward direction;
connecting the stator coils in the second group to the half-wave rectifier arrangement in the reverse direction; and
energizing the control circuitry and the stator coil to provide a magnetic flux in the axial air gap, the magnetic flux in the axial air gap being parallel to the rotational axis.

18. The method of claim 17, further comprising:
arranging a second rotor disc and a third rotor disc, each extending radially from the rotor shaft;
inserting a first plurality of rotor poles spaced equally circumferentially into the second rotor disc and the third rotor disc; and
arranging a second stator arrangement and a third stator arrangement, each have an identical configuration as the first stator arrangement;
wherein the control circuitry further comprises two half-wave rectifier arrangements in a forward direction and two half-wave rectifier arrangements in a reverse direction;
wherein the stator coils in each of the first groups are connected to the half-wave rectifier arrangement in the forward direction and the stator coils in each of the second groups are connected to the half-wave rectifier arrangement in the reverse direction.

19. The method of claim 18, wherein the second stator arrangement is indexed relative to the first stator arrangement, and the third stator arrangement is indexed relative to the second stator arrangement.

20. The method of claim 18, wherein the second rotor disc is indexed by a third of the rotor sector angle relative to the first rotor disc, and the third rotor disc is indexed by a third of the rotor sector angle relative to the second rotor disc.
